(19) United States
(12) Patent Application Publication
(10) Pub. No.: US 2021/0370239 A1
(43) Pub. Date: Dec. 2, 2021

(54) POLYMER LAYERED HOLLOW FIBER MEMBRANE BASED ON POLY(2,5-BENZIMIDAZOLE), COPOLYMERS AND SUBSTITUTED POLYBENZIMIDAZOLE

(71) Applicant: COUNCIL OF SCIENTIFIC AND INDUSTRIAL RESEARCH, New Delhi (IN)

(72) Inventors: Ulhas Kanhaiyalal KHARUL, Pune, Maharashtra (IN); Harshal Dilip CHAUDHARI, Pune, Maharashtra (IN); Nishina Achuthan SHOBHANA, Pune, Maharashtra (IN); Nitin Madhukarrao THORAT, Pune, Maharashtra (IN); Lavanya ALLADI, Pune, Maharashtra (IN); Vipin KUMAR, Pune, Maharashtra (IN); Saroj Shivram GAWAS, Pune, Maharashtra (IN); Shebeeb Hassan KUNJATTU, Pune Maharashtra (IN)

(21) Appl. No.: 17/285,942

(22) PCT Filed: Oct. 21, 2019
(86) PCT No.: PCT/IN2019/050776

§ 371 Date: Apr. 16, 2021

(30) Foreign Application Priority Data
Oct. 20, 2018 (IN) 201811014986

(51) Int. Cl. B01D 69/08; B01D 67/00; B01D 69/12; B01D 71/82

(52) U.S. Cl. CPC B01D 69/087; B01D 67/0088; C08G 73/18; B01D 71/82; B01D 69/12

(57) ABSTRACT

The present invention relates to a polymer layered hollow fiber membrane based on poly(2,5-benzimidazole) (ABPBI), ABPBI copolymers and substituted polybenzimidazole (PBI) and a process for preparation thereof.

### FIELD OF THE INVENTION

The present invention relates to a polymer layered hollow fiber membrane based on poly(2,5-benzimidazole) (ABPBI), poly(2,5-benzimidazole) (ABPBI) copolymers and substituted polybenzimidazole (PBI). Particularly, the present invention relates to a process for the preparation of polymer layered hollow fiber membrane based on poly(2,5-benzimidazole) (ABPBI), poly(2,5-benzimidazole) (ABPBI) copolymers and substituted polybenzimidazole (PBI).

### BACKGROUND AND PRIOR ART OF THE INVENTION

Inorganic acids are commonly used in many industries such as steel, metal surface treatment and refining (Cr, Ni, Zn, Cu, etc.), electronics, chemical manufacture, etc. Their processing at various stages generates a large amount of acid solution streams. The membrane technology is the most feasible approach; due to its operational simplicity, acceptable permeation properties, low energy requirement, environmental compatibility, easy control, and scale-up and large operational flexibility. However, application of polymeric membranes is limited mainly due to the poor membrane stability towards high acid concentration, co-transport of other solutes leading to poor selectivity and membrane fouling. Further, microporous flat sheet and hollow fiber membranes are well known in the art. Such membranes are typically made by a solution-casting process (flat sheets) or by a solution extrusion-precipitation process (hollow fibers). Membranes made from conventional polymers cannot be used to treat feed streams containing solvents, acids or other harsh chemicals. To overcome these shortcomings, an efficient membrane is needed.

Polybenzimidazole (PBIs) are a family of polymer widely used in different applications due to its high thermal chemical and mechanical stability. The polymer backbone consists of heteroaromatic moiety with N—H group which furnish excellent rigidity to the polymer. This outstanding rigidity of PBIs imparts the capability to sustain at a high and cryogenic temperature which makes it a suitable candidate for gas separation application. The poor permeability and solubility of PBIs lead to the necessity of structural modification. The first effort was a structural modification of acid and amine moiety with the bulky group, still, the performance was not competing with the other polymers. Structural modification by N-substitution was the other approach to enhance the permeability, tertiarybutylbenzyl substituted polymer was successfully synthesized having 4 and 17 times enhanced the permeability than the parental polymer PBI-BuI and PBI-I respectively. These properties were demonstrated on the flat sheet form (film of ˜40-50 μm thickness). For practical applications of gas separations, the membrane needs to be asymmetric with a thin skin of ˜10 μm thickness supported on the porous substructure. This way, high flux while retaining intrinsic selectivity of the skin layer can be obtained. Making hollow fiber membranes based on solely PBI does not make practical sense due to the high cost of the monomer and to extract the better membrane performance. The dual-layer hollow fiber membranes can address the discussed issues.

The energy requirement of the forward osmosis process is ˜10% in comparison to the reverse osmosis and is less prone to the fouling than the pressure-driven membrane processes. In industrial applications, especially in pharmaceutical and fine chemicals, the use of an organic solvent is necessary. Most of the present polymeric membranes do not withstand the organic solvent. It thus becomes necessary to improve the solvent stability of the membranes, which becomes the aim of the present work.

Pervaporation is established for the dehydration of organic solvents. One of the major drawbacks of polymeric membranes is their limited solvent stability. The uses of polymeric membranes are also restricted by temperature limitation.

WO-2011104602 discloses a porous ABPBI [phosphoric acid doped poly (2,5-benzimidazole] membrane and process of preparing the same, wherein the ABPBI porous membranes have excellent stability towards strong acids, bases, common organic solvents, and harsh environmental conditions.

Although conventional PBI is demonstrated for making its hollow fiber membranes in U.S. Pat. No. 6,986,844B2 as well as dual-layer membranes in US-20110266222, ABPBI based hollow fibers are not demonstrated in the literature for separation applications. They can be used for several applications such as pervaporation, forward osmosis, gas separation, etc. Although the excellent solvent and temperature stability of ABPBI is demonstrated in the literature, it is not demonstrated for hollow fiber membrane preparation for separation applications.

So there is need to develop a hollow fiber membrane based on poly(2,5-benzimidazole) (ABPBI), ABPBI copolymers and substituted polybenzimidazole (PBI).

### Objectives of the Invention

The main objective of the present invention is to provide a substantially non-porous polymer layered hollow fiber membrane based on poly(2,5-benzimidazole) (ABPBI), poly(2,5-benzimidazole) (ABPBI) copolymers and substituted polybenzimidazole (PBI).

Another objective of the present invention is to provide a process for the preparation of the substantially non-porous polymer layered hollow fiber membrane based on poly(2,5-benzimidazole) (ABPBI), poly(2,5-benzimidazole) (ABPBI) copolymers, blends and substituted polybenzimidazole (PBI).

Yet another object of the present invention is to provide use of the polymer layered hollow fiber membrane for separation or transport of solvents, solutes, acids, bases, chemicals and gases in selective manner.

### SUMMARY OF THE INVENTION

Accordingly, present invention provides a polymer layered fiber membrane comprising one to three polymers layers wherein
i. the polymer for a first layer is selected from the group consisting of poly(2,5-benzimidazole)(ABPBI), or poly(2,5-benzimidazole) (ABPBI) copolymers, or substituted polybenzimidazole (PBI) or blends thereof;
ii. the polymer for a second layer is selected from the group consisting of polyetherimide, polyamide, polyacrylonitrile, polysulfones, polyether sulfone, polyvinylidene fluoride, polyimide, polyphenylene oxide, cellulose acetates alone or in combinations thereof;
iii. the polymer for a third layer is selected from the group consisting of silicone rubber, ethyl cellulose, poly(phyneleneoxide), poly(tetramethyl bisphenol-A-iso-terephthalate) or poly[1-(trimethylsilyl)-1-propyne;
wherein one layer of said membrane is polymer of first layer;
wherein said membrane is hollow fiber and substantially non-porous.

In an embodiment of the present invention, poly(2,5-benzimidazole) (ABPBI) copolymers is selected from the group consisting of ABPBI-co-PBI, ABPBI-co-substituted PBI or ABPBI-co-naphthalene dicarboxylic acid based PBIs.

In another embodiment of the present invention, said substituted polybenzimidazole is selected from the group consisting of tert-butyl substituted polybenzimidazole, hexafluoroisopropylidene substituted polybenzimidazole, dimethylsubstituted polybenzimidazole or di-tert-butylbenzyl substituted polybenzimidazole.

In yet another embodiment of the present invention, said membrane is useful for separation or transport of solvents, solutes, acids, bases, chemicals and gases in selective manner.

In yet another embodiment, present invention provides a process for the preparation of polymer membrane comprising the steps of:
a) preparing a first dope solution by dissolving the first polymer in a solvent or solvent mixtures followed by stirring the mixture at temperature in the range of 60 to 120° C. for the period in the range of 1 to 72 h;
b) preparing a second dope solution by dissolving second polymer in solvent followed by stirring the reaction mixture at temperature in the range of 60 to 90° C. for the period in the range of 1 to 72 h;
c) subjecting the first dope solution of step (a) and second dope solution of step (b) to dry-jet/wet spinning process to afford polymer layered hollow fiber membrane; and
d) coating the membrane of step (c) with a third polymer to afford three layered membrane.

In yet another embodiment of the present invention, wherein said solvent is selected from group consisting of pyridine, dimethyl sulfoxide, N,N-dimethyl formamide, N,N-dimethyl acetamide, N-Methyl-2-pyrrolidone, methane sulphonic acid, sulphuric acid, phosphoric acid, polyphosphoric acid, formic acid, acetone, tetrahydrofuran or mixture thereof.

In yet another embodiment of the present invention, said first polymer is selected from the group consisting of poly(2,5-benzimidazole), or poly(2,5-benzimidazole) copolymers, or substituted polybenzimidazole; wherein said substituted polybenzimidazole are selected from tert-butyl substituted polybenzimidazole, hexafluoroisopropylidene substituted polybenzimidazole, dimethylsubstituted polybenzimidazole, di-tert-butylbenzyl substituted polybenzimidazole.

In yet another embodiment of the present invention, said second polymer is selected from the group consisting of polyetherimide, polyamide, polyacrylonitrile, polysulfones, polyether sulfone, polyvinylidene fluoride, polyimide, polyphenylene oxide, cellulose acetates either alone or combination thereof.

In yet another embodiment of the present invention, said third polymer is selected from the group consisting of silicone rubber, ethyl cellulose, poly(phyneleneoxide), poly(tetramethyl bisphenol-A-iso-terephthalate) or poly[1-(trimethylsilyl)-1-propyne.

### Abbreviation

ABPBI: Poly(2,5-benzimidazole)

PBI: Polybenzimidazole

PAN: Polyacrylonitrile

PSF: Polysulfones

PBI-BuI: Tert-butyl group substituted polybenzimidazole

PEI: Polyetherimide

PA: Polyamide

PAN: Polyacrylonitrile

PES: Polyether sulfone

PVDF: Polyvinylidene fluoride

PI: Polyimide

PPO: Polyphenylene oxide

CA: Cellulose acetates

PTMSP: poly[1-(trimethylsilyl)-1-propyne

### BRIEF DESCRIPTION OF THE DRAWINGS

FIG. 1: Optical image of a neat ABPBI based hollow fiber membrane.

FIG. 2: Optical image of dual layer ABPBI-PAN fiber; (a)—ABPBI layer and (b)—PAN layer

FIG. 3: Optical image of dual layer PBI-BuI-PSF fiber; (a)—PBI-BuI layer and (b)—PSF layer.

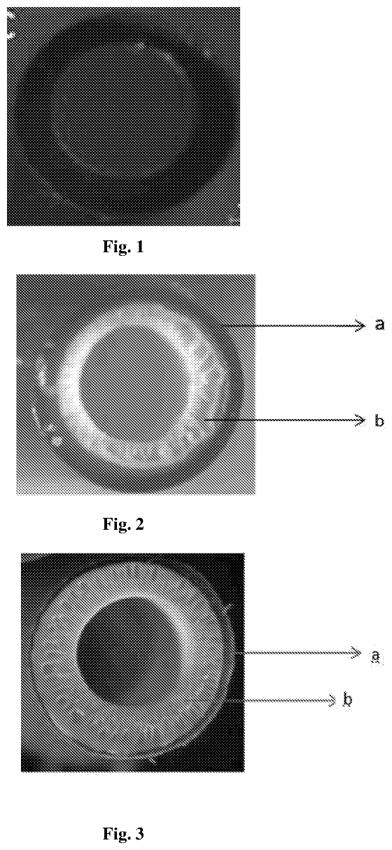

### DETAILED DESCRIPTION OF THE INVENTION

The term “substantially non-porous” states that “a membrane that is substantially non-porous is a membrane capable of being used for chemodialysis, forward osmosis, pervaporation, gas separation, nanofiltration, ultrafiltration or reverse osmosis.”

The present invention provides a polymer layered hollow fiber membrane based on poly(2,5-benzimidazole) (ABPBI), poly(2,5-benzimidazole) (ABPBI) copolymers and substituted polybenzimidazole (PBI) and a process for the preparation thereof.

The present invention provides a substantially non-porous polymer layered hollow fiber membrane comprising one or more polymers layers, wherein
i. the polymer for a first layer is selected from the group consisting of poly(2,5-benzimidazole) (ABPBI), poly(2,5-benzimidazole) (ABPBI) copolymers, or substituted polybenzimidazole (PBI) or blends thereof;
ii. the polymer for a second layer is selected from the group consisting of polyetherimide (PEI), polyamide (PA), polyacrylonitrile (PAN), polysulfones (PS), polyether sulfone (PES), polyvinylidene fluoride (PVDF), polyimide (PI), polyphenylene oxide (PPO), cellulose acetates (CA) alone or in combinations thereof;
iii. the polymer for third layer is selected from the group consisting of silicone rubber, ethyl cellulose, poly(phyneleneoxide), poly(tetramethyl bisphenol-A-iso-terephthalate) or poly[1-(trimethylsilyl)-1-propyne (PTMSP);

with the proviso that one layer of the membrane is polymer of first layer and when the membrane wherein the polymer layered hollow fiber membrane is substantially non-porous.

In an embodiment of the present invention, poly(2,5-benzimidazole) (ABPBI) copolymer is selected from the group consisting of ABPBI-co-PBI, ABPBI-co-substituted PBI or ABPBI-co-naphthalene dicarboxylic acid based PBIs.

The single layered membrane further comprises blends of poly(2,5-benzimidazole) (ABPBI) or its copolymer or their blends with substituted polybenzimidazole (PBI).

The thickness of the layer of single, double or three layer membrane is in the range of 0.05 to 300 μm.

The non-porous polymer layered hollow fiber membrane based on poly(2,5-benzimidazole) (ABPBI), ABPBI copolymers and substituted polybenzimidazole (PBI) further comprising the polymer of third layer.

The polymer for third layer is selected from Silicone rubber, ethyl cellulose, poly(phyneleneoxide), poly(tetramethyl bisphenol-A-iso-terephthalate) or poly[1-(trimethylsilyl)-1-propyne (PTMSP).

The substituted polybenzimidazole is selected from tert-butyl substituted polybenzimidazole, hexafluoroisopropylidene substituted polybenzimidazole, dimethylsubstituted polybenzimidazole, di-tert-butylbenzyl substituted polybenzimidazole

The structure of poly(2,5-benzimidazole) (ABPBI), is disclosed in the reference WO-2011104602.

The structure of tert-butyl substituted polybenzimidazole is disclosed in the reference J. Membr. Sci. 286 (2006) 161.

The structure of hexafluoroisopropylidene substituted polybenzimidazole is disclosed in the reference J. Membr. Sci. 286 (2006) 161.

The structure of dimethylsubstituted polybenzimidazole is disclosed in the reference Eur. Polym. J. 45 (2009) 3363.

The structure of di-tert-butylbenzyl substituted polybenzimidazole is disclosed in the reference Eur. Polym. J. 45 (2009) 3363.

The present invention provides a process for the preparation of the substantially non-porous polymer layered hollow fiber membrane comprising the steps of:
a) preparing a first dope solution by dissolving the first polymer in a solvent or solvent mixtures followed by stirring the mixture at temperature in the range of 60 to 120° C. for the period in the range of 1 to 72 h;
b) preparing a second dope solution by dissolving second polymer in solvent followed by stirring the reaction mixture at temperature in the range of 60 to 90° C. for the period in the range of 1 to 72 h;
c) subjecting the first dope solution of step (a) and second dope solution of step (b) to dry-jet/wet spinning process to afford one or two layered hollow fiber membrane; and
d) coating the membrane of step (c) with a third polymer to afford three layered membrane.

The solvent is selected from the group consisting of pyridine, dimethyl sulfoxide, N,N-dimethyl formamide, N,N-dimethyl acetamide, N-Methyl-2-pyrrolidone, methane sulphonic acid, sulphuric acid, phosphoric acid, polyphosphoric acid, formic acid, acetone, tetrahydrofuran or mixture thereof.

The first polymer is selected from the group consisting of poly(2,5-benzimidazole) (ABPBI), or poly(2,5-benzimidazole) (ABPBI) copolymers, or substituted polybenzimidazole (PBI) or blends thereof.

The second polymer is selected from the group consisting of polyetherimide, polyamide, polyacrylonitrile, polysulfones, polyether sulfone, polyvinylidene fluoride, polyimide, polyphenylene oxide, cellulose acetates alone or in combinations thereof.

The third polymer is selected from the group consisting of Silicone rubber, ethyl cellulose, poly(phyneleneoxide), poly(tetramethyl bisphenol-A-iso-terephthalate) or poly[1-(trimethylsilyl)-1-propyne (PTMSP).

The present invention further provides use of the polymer layered hollow fiber membrane for separation or transport of solvents, solutes, acids, bases, chemicals and gases in selective manner.

The present invention further provides the hollow fiber membrane modules of having different shapes. In the present invention, shell and tube type and U-shaped membranes modules are used for transport analysis. The transport analysis is carried out by flux studies. Different solvents, solutes, acids, bases, chemicals and gases are used for transport analysis.

The shell and tube type membrane module is prepared by potting the hollow fiber membrane by using two-component epoxy glue. When the shell and tube type membrane module is used for transport analysis, feed solution is passed through shell side and stripping solution is passed through tube side or vice versa.

The U-shaped membrane module is prepared by potting the hollow fiber membrane by using two-component epoxy glue. When the U-shaped membrane module is used for transport analysis, module is dipped in the feed solution container (feed side) and the stripping solution is passed through tube side (strip side) or vice versa.

The U-shaped membrane module is used for the transport analysis of acid. In the present invention, inventor studies the transport analysis by dipping U-shaped module into the acid container (feed side) and water was circulated from the tube side (strip side). The transport of different acids viz., HNO₃, H₂SO₄ or H₃PO₄ was evaluated at different concentrations: 0.5 M, 1 M, 1.5 M and 2M. The flux of acid (amount transported from feed side to tube side) transported on the tube side is monitored by sampling and titration. The flux data for single layer membrane is given in Table 1.

TABLE 1
Flux of inorganic acids for single layer membrane

| | Flux of acid (g · m⁻² · h⁻¹) | | | |
|---|---|---|---|---|
| | At feed | At feed | At feed | At feed |
| | concentra- | concentra- | concentra- | concentra- |
| Acid | tion = 0.5M | tion = 1.0M | tion = 1.5M | tion = 2.0M |
| HNO₃ | 87.0 | 178.2 | 231.5 | 524.5 |
| H₂SO₄ | 62.1 | 64.9 | 128.9 | 246.9 |
| H₃PO₄ | 24.1 | 43.1 | 49.5 | 71.3 |

The transport of organic acids from the feed side to the tube side (strip side) of the membrane module was evaluated using acetic acid, glycolic acid, and lactic acid. The feed concentration for individual acid was varied from 0.5 M, 1.5M and 2M and the acid transported to the tube side was evaluated by titration. The flux data is given in Table 2.

TABLE 2
Flux of organic acids for single layer membrane

| | Flux of acid (g · m⁻² · h⁻) | | |
|---|---|---|---|
| | At feed | At feed | At feed |
| | concentration = | concentration = | concentration = |
| Acid | 0.5M | 1.5M | 2M |
| Acetic acid | 36.5 | 84.5 | 258.6 |
| Glycolic acid | 36.1 | 77.2 | 188.7 |
| Lactic acid | 21.11 | 64.9 | 107.8 |

The shell and tube type membrane module was used for gas permeation analysis. The individual gas (He, N₂, CO₂ or CH₄) was pressurized to the shell side of the membrane at either 50, 60 or 70 psi. The permeation analysis is as given in Table 3

TABLE 3
Gas permeation data of PEI and PBI-BuI dual-layer
hollow fiber membrane coated with silicon rubber

| Feed P | He | N₂ | CO₂ | CH₄ | Selectivity | Selectivity | Selectivity |
|---|---|---|---|---|---|---|---|
| (psi) | (GPU) | (GPU) | (GPU) | (GPU) | (He/N₂) | (CO₂/N₂) | (CO₂/CH₄) |
| 50 | 1.04 | 0.02 | 0.15 | 0.02 | 49.14 | 7.09 | 6.89 |
| 60 | 1.15 | 0.02 | 0.18 | 0.02 | 49.11 | 7.67 | 8.25 |
| 70 | 1.21 | 0.03 | 0.16 | 0.03 | 46.52 | 6.22 | 5.78 |

### EXAMPLES

Following examples are given by way of illustration therefore should not be construed to limit the scope of the invention.

### Example 1: Preparation of ABPBI and Copolymers

### Example 1a: Preparation of ABPBI

The ABPBI was synthesized in a reactor equipped with an overhead stirrer. It was charged with polyphosphoric acid (PPA, 2100 g) and heated at 170° C. A 70 g of 3,4-diaminobenzoic acid (DABA) was added and heated for 1 h. The temperature was raised to 200° C., maintained for 1 h while stirring. The polymer was precipitated in water, cut into pieces, crushed, and agitated in water till the water wash was neutral to pH. It was then agitated in 1% NaOH solution for 12 hours, then washed with water till the filtrate was neutral to pH. The obtained polymer was filtered, soaked in acetone, again filtered and then dried in a vacuum oven at 100° C. for 5 days.

### Example 1b: Preparation of Co-ABPBI-1

A 2300 g of PPA, 100 g of 3,4-diaminobenzoic acid and 14.1 g of 2,6-naphthalenedicarboxylic acid were added to a three-neck round flask. The temperature was raised to 170° C. and maintained for 3.5 h. The temperature was then lowered to 140° C., 13.9 g of 3,3′-diaminobenzidine was added, stirred for 0.5 h and the temperature was raised to 170° C. for 1 h. The temperature was further elevated to 200° C. and maintained for 5 h. The polymer was precipitated in water and processed as given in Example 1a in order to obtain the dried polymer.

### Example 1c: Preparation of Co-ABPBI-2

The co-ABPBI-2 was prepared by adding 2300 g of PPA, 60 g of 3,4-diaminobenzoic acid and 32.8 g of isophthalic acid in a reactor. The temperature was raised to 170° C. and maintained for 3.5 h with stirring. The temperature was lowered down to 140° C., 42.3 g of 3,3′-diaminobenzidine was added and stirred for 0.5 h. The temperature was then raised to 170° C. and stirred for 1 h. The temperature was further elevated to 200° C. and the reaction mixture was stirred for 5 h. The polymer was precipitated in water, cut into pieces and processed as given in Example 1a in order to obtain the polymer.

### Example 1d: Preparation of Co-ABPBI-3

The co-ABPBI-3 was prepared as given in Example-1c, except, the terephthalic acid was used in place of isophthalic acid.

### Example 1e: Preparation of Co-ABPBI-4

The co-ABPBI-4 was prepared by adding 3070 g of PPA, 60 g of 3,4-diaminobenzoic acid and 8.5 g of 2,6-naphthalenedicarboxylic acid into a reactor. The temperature of the reactor was raised to 170° C. and maintained for 1.5 h. Then 26.2 g of terephthalic acid was added and stirred for 1 h. The temperature was lowered down to 140° C. and 42.3 g of 3,3′-diaminobenzidine was added and stirred for 0.5 h. The temperature was again raised to 170° C. for 1 h and then to 200° C. and maintained for 3 h while stirring. The polymer was precipitated in water, cut into pieces and processed as given in Example 1a in order to obtain the polymer in dry form.

### Example 2: Preparation of Substituted Polymers

### Example 2a

The tert-butyl group substituted polybenzimidazole, PBI-BuI was synthesized as given in prior art (J. Membr. Sci. 286 (2006) 161).

### Example 2b

The hexafluoroisopropylidene substituted polybenzimidazole, PBI-HFA was prepared as given in the prior art. (J. Membr. Sci. 286 (2006) 161).

### Example 2c

The dimethylsubstituted polybenzimidazole, DMPBI-BuI was prepared as given in the prior art (Eur. Polym. J. 45 (2009) 3363).

### Example 2d

The di-tert-butylbenzyl substituted polybenzimidazole was prepared as given in the prior art (Eur. Polym. J. 45 (2009) 3363).

### Example 2e

The N-sodium salt of PBI-BuI was reacted with methyl iodide to form a polyionic liquid, as given in the prior art (US-20130184412A1, Polym. Chem. 5 (2014), 4083). A 3-necked round-bottomed flask was charged with 600 ml of dry DMSO, added 20 g of PBI (PBI-I or PBI-BuI) and 2.1 molar equivalents of NaH (60% mineral oil dispersion form) and stirred under dry N₂ atmosphere at ambient temperature for 24 h. The reaction mixture was then heated at 80° C. for an h. The reaction mixture was allowed to cool to ambient and 4.2 equivalent of methyl iodide was added. The reaction temperature was elevated to 80° C. and further stirred for 24 h, the temperature was lowered to ambient and then precipitated in a mixture of toluene-acetone (1:1). The obtained golden yellow precipitate was dried at 80° C. for 24 h. It was further purified by dissolving in DMSO and re-precipitation in the same non-solvent. The obtained polymer was dried at 80° C. for three days.

### Example 2f

The iodide anion of polyionic liquid as synthesized in Example 2e was exchanged as given in the prior art (WO-2012035556A1, Polym. Chem. 5 (2014), 4083). A two necked flask equipped with calcium chloride guard tube was charged with 5 g of a [TMPBI-BuI][I] and 100 ml of DMF. After the complete dissolution, 2 molar equivalent of AgBF₄ was added while stirring. The AgI precipitated and the anion exchanged polymer remained in the solution. The precipitated AgI was removed by centrifugation and the anion exchanged polymer ([TMPBI-BuI][BF₄]) was recovered from the supernatant by solvent evaporation.

### Example 3: Preparation of Dope Solution

### Example 3a

A round-bottomed flask equipped with a mechanical stirrer was charged with 975 g of methanesulphonic acid, heated to 80° C., added a single polymer as prepared in Example 1a-e and stirred for 24 h to obtain a dope solution of a different polymer.

### Example 3b

A round-bottomed flask equipped with a mechanical stirrer was charged with 970 g of MSA, 15 g of ABPBI, as synthesized in Example 1a and 15 g of co-ABPBI as synthesized in Example 1d and heated to 80° C. for 24 h.

### Example 3c

A round-bottomed flask equipped with a mechanical stirrer was charged with 930 g of N,N-dimethyl acetamide (DMAc), 70 g of DMPBI-BuI, synthesized as given in Example 2c, heated to 80° C. for 24 h while stirring to make a dope solution.

### Example 3d: Preparation of Dope Solution Using Polyetherimide

The dope solution was prepared in a round-bottomed flask by charging 292 g of N-methyl-2-pyrrolidone (NMP) and 108 g of polyetherimide (Ultem-1000 grade) and stirring using mechanical stirrer for 48 hours at ambient temperature.

### Example 3e: Preparation of Dope Solution Using Polyacrlonitrile (PAN)

A round-bottomed flask was charged with 740 g of N,N-dimethylformamide (DMF), heated at 60° C., added 140 g of PAN and 40 g of citric acid (CA) and stirred for 48 h.

### Example 3f: Preparation of Dope Solution Using PBI-BuI that was Synthesized as Given in Example 2a

A round-bottomed flask was charged with 770 g of N-methyl-2-pyrrolidone (NMP) and 30 g of lithium chloride (LiCl). After the dissolution of LiCl, 200 g of PBI-BuI was added. The heating at 80° C. was done for 36 hours.

### Example 3g: Preparation of Dope Solution Using PBI-HFA that was Synthesized as Given in Example 2b

A round-bottomed flask was charged with 810 g of NMP and 40 g LiCl. A 150 g of PBI-HFA was added and stirred at 80° C. for 30 hours.

### Example 4: Preparation of Hollow Fiber Membrane

### Example 4a

The hollow fiber membranes using the dope solution as prepared in Example 3a-c were prepared by phase inversion process as known in the art [U.S. Pat. No. 6,986,844B2]. In a typical procedure, the hollow fiber membranes were prepared by a dry-jet, wet spinning process. A tube-in-orifice type spinneret was used to spin the hollow fiber membrane. The water was used as a bore fluid as well as external coagulation bath. The membranes were spun at ambient temperature.

### Example 4b

The reaction mixture as prepared in Example 1a, 1b, 1c, 1d, and 1e was further diluted with methanesulphonic acid and used as a dope solution for the preparation of hollow fiber membrane by the method as given in Example 4b.

### Example 5: Preparation of Dual-Layer Hollow Fiber Membrane

### Example 5a

The dope solution as prepared in Example 3a-c was used for forming the outer layer of the dual-layer membrane. The solutions as prepared in Example 3d or 3e was used as an inner layer. The dual-layer hollow fiber membrane was spun with as known in the prior art [US-20110266222]. In a typical procedure, the hollow fiber membranes were prepared by a dry-jet, wet spinning process. The water was used as a bore fluid as well as external coagulation bath. The membranes were spun at ambient temperature.

### Example 5b

In another dual-layer type of hollow fiber membranes, the dope solution as prepared in Example 3f and 3g was used for forming the outer layer. The solutions as prepared in Example 3d or 3e was used for forming inner layer of the dual-layer membrane. The method was the same as used in Example 5a.

### Example 6: Cross-Linking of Hollow Fiber Membranes

The dried hollow fiber membrane as prepared in Example 4a, 4b, 5a or 5b were dipped in 10% (wt./wt.) 1,4-dibromobutane in acetonitrile as a solvent. The membranes were further dried at 80° C. for 24 h. The crosslinked hollow fiber membranes were coated with 1.96 wt. % of silicone rubber in petroleum ether solution.

### Example 7: Preparation of Membrane Module

The hollow fiber membrane modules as prepared in Example 4a, 4b, 5a, or 5b were potted by using two-component epoxy glue.

### Example 7A: Preparation of U-Shaped Membrane Module

The hollow fiber membrane modules as prepared in Example 4a, 4b, 5a, or 5b were potted by using two-component epoxy glue.

### Example 8: Transport Through Hollow Fiber Membrane Modules

### Example 8a: Transport Study of NaCl

The hollow fiber membrane as spun in Example 4a (using the polymer prepared as given in Example 1a, and the dope solution as prepared in Example 3a) and the module prepared as given in Example 7 was used for this study. The NaCl solution was circulated from the shell side of the membrane, while water was circulated from the bore side of the hollow fiber membrane. In different experiments, NaCl concentration was varied as 0.1 wt. %, 0.5 wt. % and 5 wt. % in water. The concentration of shell and tube side solution was continuously monitored for NaCl concentration by using online conductivity meter for 24 h. The flux of NaCl (amount transported from shell side to tube side) for 0.1, 0.5 and 5 wt. % feed concentration was found to be 1.17×10⁻³, 3.31×10⁻² and 2.13×10⁻¹ g m⁻²h⁻¹, respectively.

### Example 8b: Transport of Inorganic Acids

The hollow fiber membrane as spun in Example 4a (using the polymer prepared as given in Example 1a, and the dope solution as prepared in Example 3a) and the U-shaped module prepared as given in Example 7 was used for this study. The transport of different acids viz., HNO₃, H₂SO₄ or H₃PO₄ was evaluated at different concentrations: 0.5 M, 1 M, 1.5 M and 2M. The flux of acid (amount transported from feed side to tube side) transported on the tube side is monitored by sampling and titration. The flux data is given in Table 1. (Refer table 1)

### Example 8c: Transport of Organic Acids

The hollow fiber membranes as spun in Example 4b (using the polymer prepared as given in Example 1a, and the dope solution as prepared in Example 3a) and the module prepared as given in Example 7 was used. The transport of organic acids from the feed side to the tube side (strip side) of the membrane module was evaluated using acetic acid, glycolic acid, and lactic acid. The experiments were carried out as given in Example 8b. The feed concentration for individual acid was varied from 0.5 M, 1.5M and 2M and the acid transported to the tube side was evaluated by titration. The flux data is given in Table 2.

### Example 8d: Transport Using HNO₃+Fe(NO₃)₃ Solution

The hollow fiber membranes spun as given in Example 4a (using the polymer prepared as given in Example 1a, and the dope solution as prepared in Example 3a) and the module prepared as given in Example 7 was used for this study. The concentration of HNO₃ taken in the shell (feed) side was 1M, while the concentration of Fe(NO₃)₃ was 0.25M. The flux for HNO₃ was found to be 118.8 g·m⁻²·h⁻¹ and the flux for Fe(NO₃)₃ was found to be 1.45×10⁻² g·m⁻²·h⁻¹, offering selectivity of HNO₃ over Fe(NO₃)₃ as 8194.

### Example 8e: Transport Using H₂SO₄+FeSO₄ Solution

The hollow fiber membranes spun in Example 4a (using the polymer prepared as given in Example 1a, and the dope solution as prepared in Example 3a) and module prepared as given in Example 7 was used for this study. The acid concentration on the shell (feed) side was 1M, while the concentration of FeSO₄ was 0.25M. The flux H₂SO₄ was found to be 62.9 g·m⁻²h⁻¹ and the flux for FeSO₄ was 7.62×10⁻¹ g·m⁻²·h⁻¹. The selectivity of H₂SO₄ over FeSO₄ was found to be 83.

### Example 8f: Pervaporation Using Methanol-Water

The hollow fiber membranes spun in Example 4b (using the polymer prepared as given in Example 1a, and the dope solution as prepared in Example 3a) and module prepared as given in Example 7 was used for this study. The 90% aqueous methanol was circulated from the shell side. The tube side pressure was maintained at 700 mbar. The permeate flux was found to be 574 g·m⁻²·h⁻¹ with the selectivity of water over methanol as 55.

### Example 8g: Forward Osmosis Using NaCl as a Draw Solution

The hollow fiber membrane as spun in Example 4a (using the polymer prepared as given in Example 1a, and the dope solution as prepared in Example 3a) and module prepared as given in Example 7 was used for this study. A 2M aqueous NaCl solution was taken as a draw solution on the tube side, while DI water was used as feed solution on the shell side. The water flux was found to be 193.73 g·m⁻²·h⁻¹.

### Example 8h: Pervaporation Using IPA-Water

The dual-layer hollow fiber membranes spun in Example 5a (outer layer formed using dope solution given in Example 3a and an inner layer formed using dope solution given in Example 3d) were used to make the module as given in Example 7. A solution made with 75% IPA and 25% water was circulated from the shell side of the module. The tube side pressure was maintained at 700 mbar. The permeate flux was 33 g·m⁻²·h⁻¹. The composition of the permeate was 94% water and 6% IPA.

### Example 81: Forward Osmosis Study

The module was prepared as given in Example 7 using dual-layer hollow fibers prepared in Example 5a (outer layer formed using dope solution given in Example 3a, based on polymer prepared in Example 1a and inner layer formed using dope solution given in Example 3e). A 2M NaCl was used as the draw solution on the tube side and DI water was circulated on the shell side. The water flux obtained was 593 g·m⁻²·h⁻¹ with NaCl rejection as 99.49%.

### Example 8j: Transport of Acids in Dual-Layer Hollow Fiber Membrane

The hollow fiber membranes spun in Example 5a (outer layer formed using dope solution given in Example 3b based on polymer prepared in Example 1c and inner layer formed using dope solution given in Example 3d) were used to make module as given in Example 7. The flux of 0.5M HNO₃ was 176 g·m⁻²·h⁻¹; while the flux of 1M lactic acid was 68 g·m⁻²·h⁻¹.

### Example 8k: Gas Permeation Through Dual Layer Hollow Fiber Membrane Coated with Silicon Rubber

The hollow fiber membrane prepared as given in Example 5b (outer layer formed using dope solution given in Example 3f and inner layer formed using dope solution given in Example 3d) were used to prepare a module as given in Example 6 and 7. The individual gas (He, N₂, CO₂ or CH₄) was pressurized to the shell side of the membrane at either 50, 60 or 70 psi. The permeation analysis is as given in Table 3. Refer Table 3

### Advantages of the Invention

The polymeric materials with high Tg and chemical stability, like substituted PBI-BuI and PBI-HFA which offers high permeance and selectivity as a skin layer and, the core of which will be composed of commercial low-cost polymers.
The advantages of using ABPBI based membrane (over conventional PBI) is their higher NH-group density (molar mass of N—H group per repeat unit of a PBI) that is anticipated to lead to high acid complexation ability.
The membrane can be prepared solely with one polymer or dual-layer membranes with the inner and outer layer of adequate polymers along with ABPBI or its copolymers.
The hollow fiber membranes prepared solely with ABPBI or its copolymer can be used under harsh environment.
These hollow fibers can cater to the need of various separations such as chemodialysis, gas separation, pervaporation, reverse osmosis, forward osmosis, etc.

We claim:

1. A polymer layered fiber membrane comprising one to three polymers layers wherein
i. the polymer for a first layer is selected from the group consisting of poly(2,5-benzimidazole)(ABPBI), or poly(2,5-benzimidazole) (ABPBI) copolymers, or substituted polybenzimidazole (PBI) or blends thereof;
ii. the polymer for a second layer is selected from the group consisting of polyetherimide, polyamide, polyacrylonitrile, polysulfones, polyether sulfone, polyvinylidene fluoride, polyimide, polyphenylene oxide, cellulose acetates alone or in combinations thereof; and
iii. the polymer for a third layer is selected from the group consisting of silicone rubber, ethyl cellulose, poly(phyneleneoxide), poly(tetramethyl bisphenol-A-iso-terephthalate) or poly[1-(trimethylsilyl)-1-propyne;
wherein one layer of said membrane is polymer of first layer;
wherein said membrane is hollow fiber and substantially non-porous.

2. The polymer membrane as claimed in claim 1, wherein said poly(2,5-benzimidazole) (ABPBI) copolymers is selected from the group consisting of ABPBI-co-PBI, ABPBI-co-substituted PBI or ABPBI-co-naphthalene dicarboxylic acid based PBIs.

3. The polymer membrane as claimed in claim 1, wherein said substituted polybenzimidazole is selected from the group consisting of tert-butyl substituted polybenzimidazole, hexafluoroisopropylidene substituted polybenzimidazole, dimethylsubstituted polybenzimidazole or di-tert-butylbenzyl substituted polybenzimidazole.

4. The polymer membrane as claimed in claim 1, wherein said membrane is useful for separation or transport of solvents, solutes, acids, bases, chemicals and gases in selective manner.

5. A process for the preparation of polymer membrane as claimed in claim 1, comprising the steps of:
a) preparing a first dope solution by dissolving the first polymer in a solvent or solvent mixtures followed by stirring the mixture at temperature in the range of 60 to 120° C. for the period in the range of 1 to 72 h;
b) preparing a second dope solution by dissolving second polymer in solvent followed by stirring the reaction mixture at temperature in the range of 60 to 90° C. for the period in the range of 1 to 72 h;
c) subjecting the first dope solution of step (a) and second dope solution of step (b) to dry-jet/wet spinning process to afford polymer layered hollow fiber membrane; and
d) coating the membrane of step (c) with a third polymer to afford three layered membrane.

6. The process as claimed in claim 5, wherein said solvent is selected from group consisting of pyridine, dimethyl sulfoxide, N,N-dimethyl formamide, N,N-dimethyl acetamide, N-Methyl-2-pyrrolidone, methane sulphonic acid, sulphuric acid, phosphoric acid, polyphosphoric acid, formic acid, acetone, tetrahydrofuran or mixture thereof.

7. The process as claimed in claim 5, wherein said first polymer is selected from the group consisting of poly(2,5-benzimidazole), or poly(2,5-benzimidazole) copolymers, or substituted polybenzimidazole; wherein said substituted polybenzimidazole are selected from tert-butyl substituted polybenzimidazole, hexafluoroisopropylidene substituted polybenzimidazole, dimethylsubstituted polybenzimidazole, di-tert-butylbenzyl substituted polybenzimidazole.

8. The process as claimed in claim 5, wherein said second polymer is selected from the group consisting of polyetherimide, polyamide, polyacrylonitrile, polysulfones, polyether sulfone, polyvinylidene fluoride, polyimide, polyphenylene oxide, cellulose acetates either alone or combination thereof.

9. The process as claimed in claim 5, wherein said third polymer is selected from the group consisting of silicone rubber, ethyl cellulose, poly(phyneleneoxide), poly(tetramethyl bisphenol-A-iso-terephthalate) or poly[1-(trimethylsilyl)-1-propyne.
